(19) United States
(12) Patent Application Publication
(10) Pub. No.: US 2013/0263821 A1
(43) Pub. Date: Oct. 10, 2013

(54) Gaseous Fuel Tank and Power Tool

(71) Applicants: Nagesh Siddabasappa Mavinahally, Northridge, CA (US); Jay Sirangala Veerathappa, Los Angeles, CA (US)

(72) Inventors: Nagesh Siddabasappa Mavinahally, Northridge, CA (US); Jay Sirangala Veerathappa, Los Angeles, CA (US)

(21) Appl. No.: 13/726,554

(22) Filed: Dec. 25, 2012

Related U.S. Application Data
(60) Provisional application No. 61/586,840, filed on Jan. 16, 2012.

(51) Int. Cl. F02B 63/02

(52) U.S. Cl. CPC F02B 63/02
USPC 123/434

(57) ABSTRACT

Various embodiments include a gaseous fueled engine and fuel tank assemblies, in particular the location and attitudes of the fuel tanks. One or more fuel tanks are attached to the power tool. The fuel tank housing has slots for air flow to heat the fuel tank to off-set the drop in fuel temperature due to latent heat of evaporation of liquefied petroleum fuels. Gaseous fuel may include LPG, Butane, LNG, H2, etc.

### RELATED APPLICATIONS

The present application claims the benefit of priority of U.S. provisional application No. 61586840, filed Jan. 16, 2012 entitled “Gaseous Fuel Tank and Power Tool”, filed the entirety of which is incorporated by reference herein for all purposes.

### BACKGROUND

In conventional gasoline fueled engines used in hand-held applications, such as in chainsaws, trimmers, and blowers it is desirable to keep the engine generated heat away from the fuel tank, as it is not desirable to heat the fuel tank and gasoline fuel. However, it is desirable to keep the fuel tank and or the tank assembly of the gaseous fuel, particularly the liquefied gaseous fuel, such as LPG (propane), Butane, LNG, and similar fuels warm at about 50 to 110 deg F., which is the ambient temperature and is range when the customers use outdoor power tools such as trimmers, chainsaws, etc. The liquefied gaseous fuels, which are in gaseous state under ambient pressure and temperature conditions are stored in liquid form at ambient temperature, but at above the vapor pressure of the fuel. As the fuel is used up during the running of the engine, the temperature of the fuel in the fuel tank drops due to latent heat of evaporation of the fuel, as result, the pressure in the fuel tank reduces with reduction in temperature and eventually it is possible that the frosting on the fuel tank will be such that the fuel pressure may drop to such a level that the engine no longer runs properly due to lack of correct air-fuel ratio. Because the fuel density changes with pressure and temperature, the open loop carburetor may perform poorly if the supply pressure is not consistent. However, the pressure in the fuel tank continues to remain constant as long as the heat lost due to evaporation is made up by the heat transmitted to the fuel tank from outside, either due to convection, radiation, and or conduction. In order to transmit heat from the engine, the location of the fuel tank becomes critical, particularly when electrical and liquid coolant is not used to heat the tank. In portable tools, size and weight are also critical and as such the fuel tank has to be located and packaged to optimize the size and weight. Secondly, the size of the fuel tank dictates the dimensions of the power tool. A compact size is critical for certain applications, such as hedge trimmers, hand held blowers, and chainsaws. It is even more critical in chainsaws, where they are commonly used on trees and as such it cannot be unduly heavy and over sized as the overall operating attitudes change and areas where it is operated is typically very congested. The embodiment described here addresses such requirement for a gaseous fueled power tool. The embodiment here describes location and attitude of the LPG fuel tank for a chainsaw as an example, and similar designs can be applied to other types of portable power tools. The embodiment also describes where the ambient air is used to warm the fuel tank during operation of the tool. The ambient air going past the fuel tank gets cooler than the ambient air, which is in turn, is used to cool the engine. A fraction of the cooling air is drawn through the fuel tank assembly and mixed with ambient air to cool the engine. Alternatively, a fractional amount of cooling air past the engine, which is hotter than the ambient air can be used to warm the fuel tank. Secondly, a bi-metal switch may be used to regulate the heating air used for warming the fuel tank. Thirdly, the frame holding the fuel tank may transfer fractional amount of heat to warm the fuel tank, while major fraction of the heat from the frame may be removed by the cooling air, such that an equilibrium of heat may be maintained in the fuel tank, that is the heat of evaporation is made up by the fractional heat transfer from frame to the tank. The heat transfer from the frame to the tank may be through a special vibration dampening material such as rubber made up of certain chemical composition. To achieve the desirable goal of keeping the fuel tank from frosting, the embodiment describes the location and attitude of the fuel tank. The fuel tank is arranged to receive heat from the ambient air or from the cooling air. The mounting of the fuel tank is also described.

### SUMMARY

Various embodiments describe the location, attitude, method of clamping, fuel tank assembly, and method of heating the liquefied gaseous fuel tank in a portable power tool. Examples of the liquefied gaseous fuel having ranges of vapor pressure and latent heat of evaporation are; H2, methane, LNG, LPG, pure propane, butane, or a mixture of propane and butane. Small two and four-stroke engines are commonly used in many applications such as in hand held power tools, portable lawn and garden applications, and scooters, etc. The gaseous fuels have significant advantage over gasoline or diesel type of liquid fuels. The gaseous fuels are cleaner and have significantly lower engine out emissions in comparison to gasoline fuel. Gaseous fueled small engine are commonly used in lawn and garden tools such as chainsaws, trimmers, blowers, pumps, and also for personal transportation such as scooters.

Various embodiments describe the location and attitude of the gaseous fuel tank assembly particularly for warming the fuel tank and also from point of view overall size of the power tool, and easy access to reload the fuel tank. In the embodiment disclosed an On-Off f fuel valve is also disclosed. One example of location of the fuel tank assembly in a chainsaw is above the cooling fan (fly wheel) and closer to the starter assembly. Another example can be closer to the carburetor where the axis of the fuel tank is significantly parallel to the axis of the crankshaft or is at an angle but in a plane significantly parallel to the axis of the crankshaft. Further another location can be where the fuel tank assembly is attached to the handle of the chainsaw, which is commonly isolated from the engine block through vibration dampeners to minimize the vibration of the handle. The fuel tank assembly may be attached to the handle at many different angles that provides for compact size of the tool. Further, the fuel tank assembly may be integral with the engine housing and or the handle. The fuel tank assembly having a metal case may be over molded with the engine housing or the handle for cost and size.

### BRIEF DESCRIPTION OF THE DRAWINGS

FIG. 1 is a left side view of a chainsaw having fuel tank assembly on top left.

FIG. 2 is a sectional front view of the chainsaw 100 shown in FIG. 1.

FIG. 3 is a left side view of a chainsaw 200 having fuel tank behind the engine block.

FIG. 4 is a top view of the chainsaw shown in FIG. 3.

FIG. 5 is a left side view of a chainsaw 300 having fuel tank on the left front side of a chainsaw.

FIG. 6 is a sectional view of the chainsaw shown in FIG. 5.

FIG. 7 is a top view of fuel tank assembly 900 having a shut-off valve.

FIG. 8 is a sectional view of the fuel tank assembly 900 shown in FIG. 7.

FIG. 9 is a cross sectional view of the fuel tank assembly 900 and the chainsaw 500 with fuel tank behind the crankcase and away from the CL of the cylinder.

FIG. 10 is a side sectional view of a (top handle) chainsaw 600 with chain bar significantly in line with axis of the cylinder and fuel tank between the carburetor and the chain bar.

FIG. 11 is a side sectional view of a (top handle) chainsaw 700 with chain bar significantly in line with axis of the cylinder and fuel tank between the carburetor and the axis of the cylinder and is closer to the spark plug.

FIG. 12 shows top view of the chainsaw 700 shown in FIG. 11.

FIG. 13 shows line diagram of a dual plunger oil pump delivering two different types of oils and at different rates of each type of oil.

FIG. 14 shows front sectional view of a chainsaw having axis fuel tank in parallel to axis crankshaft attached to the base frame 368.

FIG. 15 shows front sectional view of a chainsaw having at least two fuel tanks and their axis is perpendicular to axis of crankshaft but in a different plane in a plane below the plane of the crankshaft and attached to the base frame 368.

### DETAILED DESCRIPTION

The following are hereby incorporated by reference herein for all purposes: U.S. Pat. Nos. 5,884,460, 5,918,574, and 5,606,944, 5,701,855, 4,924,822, 2,829,251, and Publication number 2011/0088650 A1.

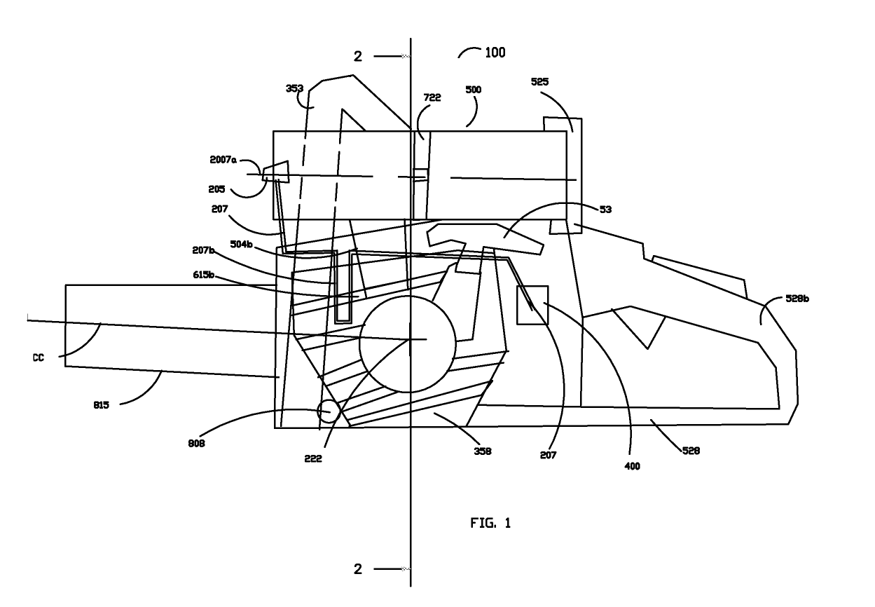

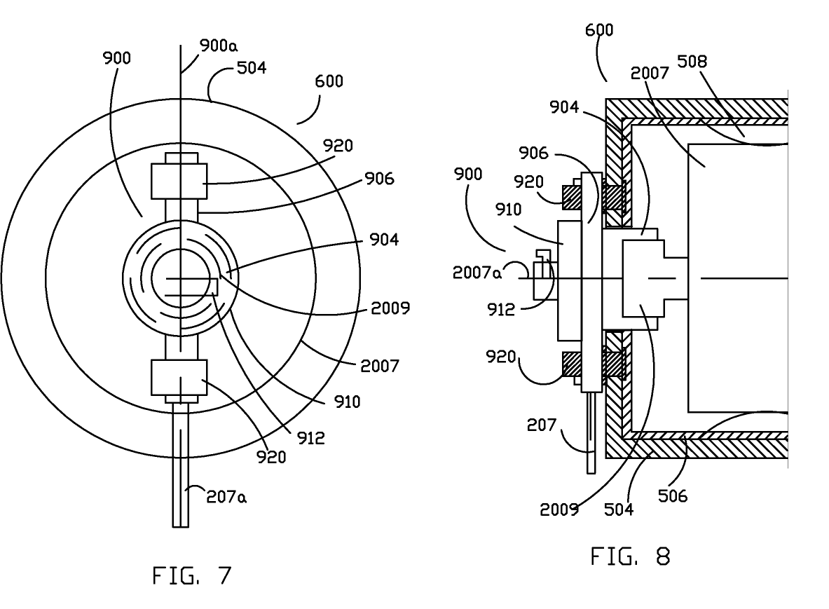

FIGS. 1, through 6 show a portable power tool having various embodiments of locations and attitudes of a gaseous fuel tank and having features to warm the fuel tank and or the assembly. U.S. Pat. No. 5,884,460 describes a method of mounting a propane fuel tank on the handle of a lawn mower. The drawback of the disclosure is that the fuel tank is mounted farther away from the heat generating internal combustion engine. As such this method of holding the fuel tank and location does not address the problem associated with the frosting on the fuel tank which affects the performance of the engine significantly. FIGS. 6 and 7 show location of the fuel tank in a chainsaw and a hedge trimmer, which again is farther away from the heat generating engine and secondly does not address the problem of frosting on the fuel tank, as the tanks are not properly encased in a fuel cage/frame that help in transmittal of heat from the ambient air or from the engine. U.S. Pat. No. 5,606,944 describes where the fuel tank is heated by the fully heated cooling air passing through the entire cylinder block 605 and cylinder head 628. The drawback is that during hot summer days when the ambient temperature is 105 deg F. or so, the temperature of the cooling air may exceed 250 deg F. and over heat the fuel tank. Secondly, fuel tank on the outlet side of the cooling air may obstruct the free flow of the cooling air.

Various embodiments overcome drawbacks and improve upon the above prior arts. The operating principle of the innovative locations and attitudes disclosed in the present embodiments are only a few examples. As such it will be understood that a person who has knowledge of engines will be in a position to execute the embodiments disclosed herein.

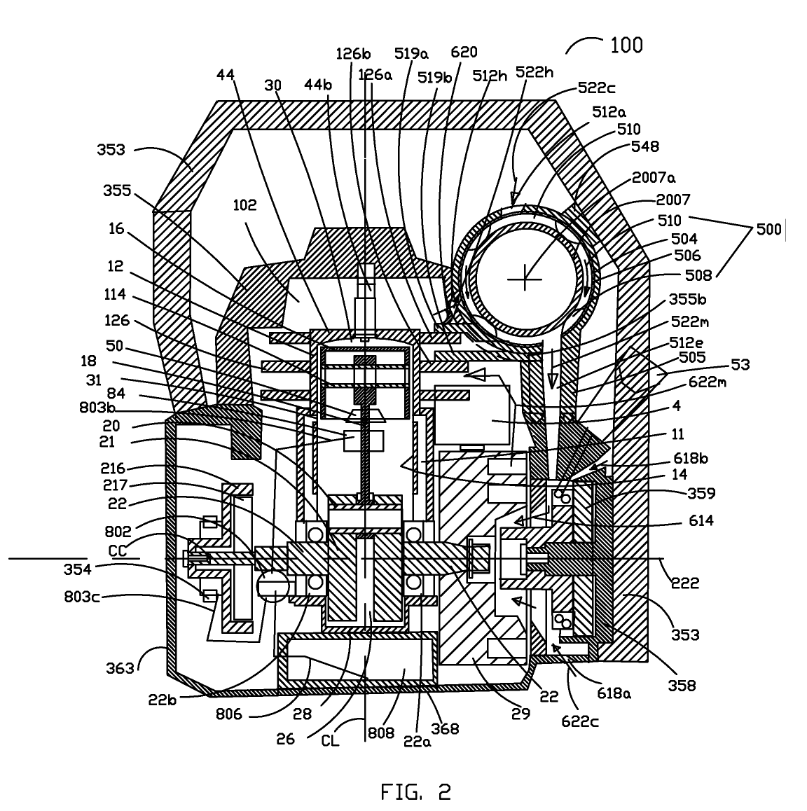

Turning to FIGS. 1 and 2 of the presently disclosed embodiments, chainsaw 100 consists of a cylinder 12 inside which is a reciprocating piston 16 connected to a crankshaft 22 through a connecting rod 18, a crankpin 20 and a piston pin 114. The crankshaft 22 has crank weight 21 and the crankshaft is supported by main bearings 22a and 22b. The crankshaft 22 is supported on both ends in a full crank engine, or on just one side in a half crank engine. The lower side of the piston has crankcase chamber 26 in the crank case 28. The cylinder 12 has cylinder bore 14 having combustion chamber 30 on the upper side of the piston 16. The crankcase chamber and combustion chamber are interconnected periodically through transfer passage 11. The cylinder has at least one intake port 84, exhaust port 50, and at least one transfer port 33. The lubricating system consists of an oil pump 802 driven by the crankshaft 22, typically mounted to the side of the crankcase wall. Oil pump 802 has an inlet oil line 806 and receives oil from oil tank 808. Oil pump 802 also has an outlet pipe 803 for injecting oil into the intake and another outlet 803 to lubricate the chain 353. The oil pump 802 may be of double acting, in the sense that it can have two inlets and two outlets to supply two different types oils to lubricate the engine and the chain with respective types of oil and rate. The cover 358 on left side of the chainsaw consists of a starter assembly 359 having open slots 618 (618a, 618b, 618c), for inlet of ambient air to cool the engine block, including cylinder 12 and cylinder head 44. The cover 358 shown in FIGS. 1 and 2 has slot 618c receiving cooling air 522m from the outlet of the fuel tank assembly 500. Fuel tank assembly 500 consists of the replaceable LPG or Butane fuel tank 2007, which are typically cylindrical in shape, having height bigger than the diameter, circumferentially and intermittently spaced supporting members 508 around the tank 2007, a metal casing 506, and plastic housing 504 having at least one open slot 512a for ambient air and at least one open slot 512h for warmer engine air to circulate around the fuel tank 2007 and the fuel tank assembly having an outlet 5120 leading into the open slot 618c in the cover 358. The ambient air 522c entering the open slot 512a and fraction of the air that has passed through the cooling fins 126 of the engine cylinder 12 and cylinder head 44 entering the open slot 512h pass around the fuel tank 2007 transferring heat to the fuel tank 2007. Thus making up for the latent heat of evaporation of the fuel and maintaining a reasonable constant temperature of the fuel tank. The air passing around the fuel tank 2007 before exiting transfers heat to the cooler fuel tank 2007. The amount of air entering the open slot 512h on the engine side is regulated by the bimetal valve 620. As the engine gets hotter, temperature of the air entering the open slot 512h increases, as a result of increase in temperature of the air, the bimetal valve 620 restricts the hot air flowing through the open slot 522h. Thus a smaller fraction of hot air now flows through the open slot 512h to prevent over heating of the fuel tank 2007.

The embodiment disclosed in FIGS. 1 and 2 show that the fuel tank assembly 500 is located above the cooling fan 29 and in the segment between the vertical axis CL of the cylinder 12 and the center line 222 of the crankshaft 22. The fuel tank assembly 500 is located below the top level of the handle 353, thus the overall height of the gaseous fueled chainsaw is same as a gasoline fueled chainsaw. The embodiment also shows that the fuel tank assembly 500 having a elements 519a and 519b, which are metal tabs extended from the metal casing 506 are attached to a section of the cooling fins 126a and 126b to transfer heat from the cylinder 12 to the fuel tank 2007 through convective heat transfer by the air between the casing 506 and the fuel tank 2007. The heat is also conducted to the metal casing 506 and the fuel tank 2007 through the supporting members 508. Therefore the amount of heat transferred from the fins to the fuel tank can be determined by the area of contact between the elements 519 and fins 126. The Chainsaw 100 has a top cover 355 and cover 363 on the right side of the chainsaw. The top cover 355 may house a fraction of the fuel tank assembly 500 by having a curvature 355 to conform to the shape of the fuel tank casing 504. Alternatively, the plastic housing 504 may be integrally molded to the top cover 355 and the fuel tank 2007 may be clamped to the fuel tank housing 504 by means of at least one U strap/clamp 722, as used in many applications and similar to the one disclosed in prior art U.S. Pat. No. 2,829,251 and another being a method to fasten larger LPG tanks in a fork lift as disclosed in U.S. Pat. No. 5,330,031. Alternatively, a end cap 525, as described in prior art U.S. Pat. No. 5,606,944, may be used to hold the fuel tank 2007 in place. FIG. 1 also shows an On-off valve 205 to shut of the fuel when the engine is not running. The shut off valve 205 may be affixed to the fuel tank assembly 500. The on-off valve also be an integral with a primary pressure regulator. Pressure regulators are used to reduce the high pressure in fuel tank to lower pressure such that the supply pressure to the carburetor is lower. Also, the primary pressure regulator may be attached to a heat sink, such as cylinder head or cylinder cooling fins 126 or crankcase 28 so that the liquid fuel is converted to vapor. The connection between the fuel tank 2007 and the fuel shut-off valve 205 may be just a press fit and where the fuel tank is held in place by an end cap 525, as described in prior art U.S. Pat. No. 5,924,400 and or a threaded connection as used in most 1 lb fuel tanks sold in US. The threaded fuel tank may directly be screwed on to the pressure regulator cum on-off valve assembly as used in most pressure regulators used in Asian countries (reference to be provided) and shown in FIGS. 7 and 8. Just the threaded type connector 904 without the pressure regulator 910 may be mounted on a dampening material 920, such as rubber pads to minimize the transfer of vibration from the engine frame to the fuel tank 2007. In which case, there may be a small section of flexible fuel hose 207a between the fuel tank assembly/pressure regulator 900 and a metal pipe 207. Metal pipe may then be attached to engine for receiving heat to vaporize the fuel.

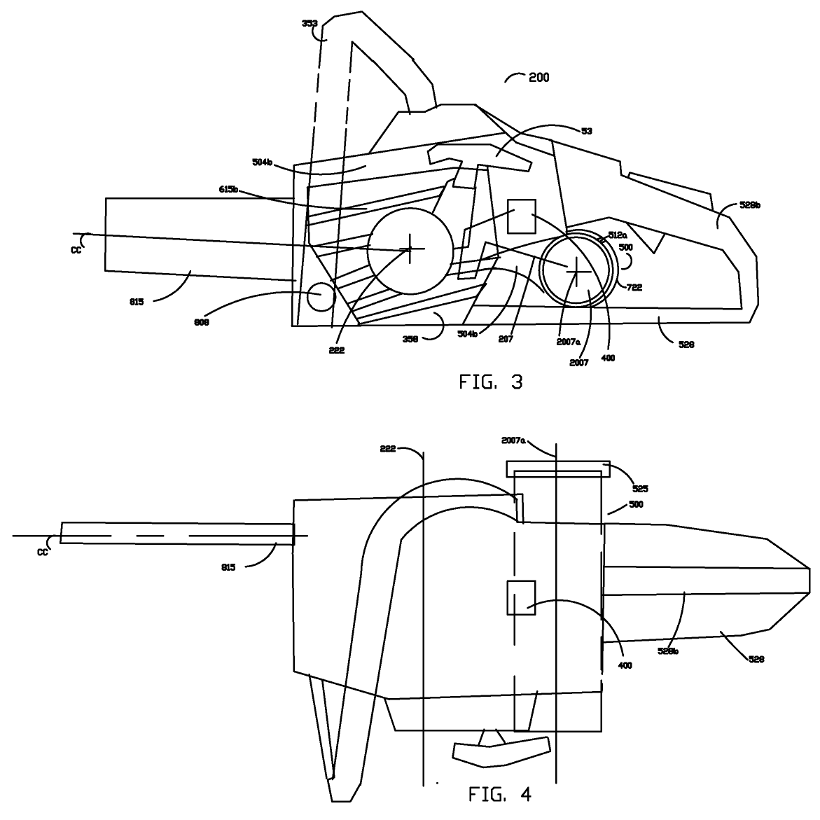

FIGS. 3 and 4 show another embodiment showing the location of the fuel tank 2007 in a chainsaw 200. In this embodiment the fuel tank assembly 500 is located horizontal in a plane substantially parallel to the plane passing through the axis 222 of the crankshaft 22. The fuel tank assembly is located behind the engine block 102, away from the chain 354. The fuel tank may be at an angle with the fuel outlet pointing upward. It is also possible for the fuel tank to be attached to the crankcase wall 28, as described in a prior art published in US2011/0088650, FIG. 4f, but in this new embodiment, the axis 2007a of the fuel tank 2007 and the axis 222 of the crankshaft 22 are substantially parallel to each other. It is possible for the fuel tank frame 504 to be integrally molded with the base 528 of the chainsaw. Secondly it is possible for at least one of the metal tabs 519a or 519b to be attached to the crankcase 28, as shown in the prior art U.S. Pat. No. 5,606,944. The fuel tank 2007 may be held in place by means of U straps 722, which may in turn be affixed to the base 528, or may have an end cap 525, particularly when the housing 504 is integral with the base 528.

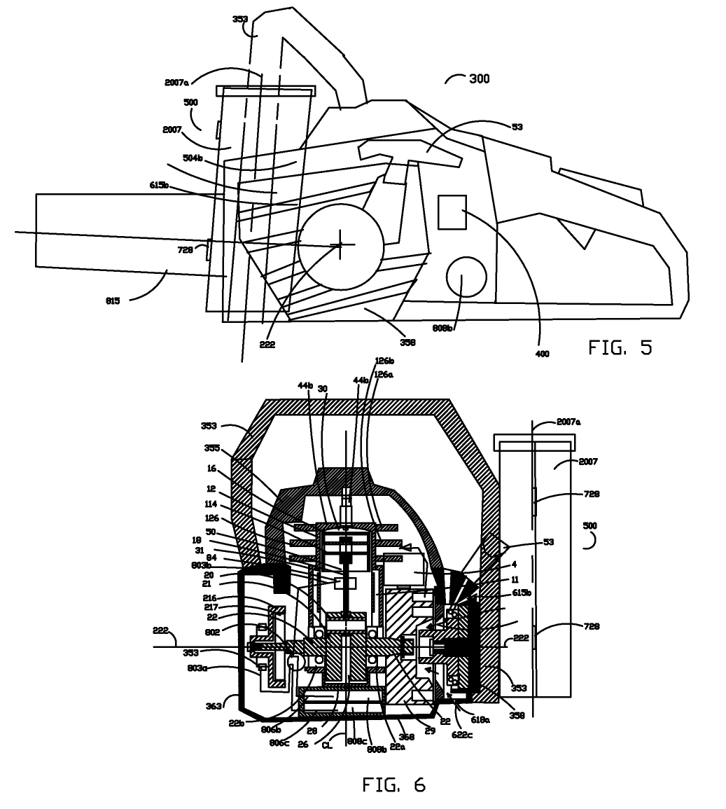

FIGS. 5 and 6 show another embodiment 300 where the fuel tank assembly 500 is substantially vertical attitude. The fuel tank assembly 500 may be clamped to the handle 353, or may be attached to one of the side covers 358 or 363. FIG. 5 shows here the fuel tank assembly 2007 is toward the front of the crankshaft 22 in a vertical attitude. Alternatively, the fuel tank may also be located toward the back of the crankshaft 22. The attitude of the fuel tank 2007 may be at an angle on a plane perpendicular to the axis 222. When the fuel tank 2007 is mounted to the handle 353, which is isolated from the engine to minimize vibration, flexible fuel supply line may be used to supply fuel to the carburetor 400. Alternatively a metal pipe 207 may be used as shown in FIG. 1, and the fuel line may be attached to the engine or disposed around the cooling air outlet to heat the fuel line for vaporization of fuel, as described in prior art U.S. Pat. No. 5,924,400. In another embodiment, there can be more than one fuel tank attached to the tool for extended use of the tool. The location of multiple fuel tanks can be a combination of different locations and attitudes. FIG. 6 shows an oil pump delivering two separate types of oils; one to the engine and the other to the chain from two different oil tanks 806b and 806c. Since the characteristics of the oils are different for chain and engine, it may be necessary to have separate oil tanks. A single oil pump with one plunger with different plunger diameters for two different oil delivery rates may be employed. However, oil common to both; the chain and engine may also be used requiring only one oil tank 806, as shown in FIG. 2.

FIGS. 7 and 8 show another embodiment of the fuel tank assembly 600 having a connector assembly 900 with a vibration dampening bushing 920 between the fuel tank housing 504 and the connector assembly 900. The connector assembly 900 has a threaded collar 904, which is used with fuel tank 2007 having a threaded outlet 2009 as used in 1 lb LPG tank, or a press fit type as used in certain type of Butane tanks, an arm 906, which may have built in on-off valve 912 and optional pressure regulator 910, and having a flexibly fuel hose 207a. The arm 906 is mounted on to the fuel tank housing 504 through vibration dampening bushing 920. The advantage with this embodiment is that when the fuel tank is threaded on to the collar, the collar can self align with the outlet 2009. Secondly the connector assembly 900 may be rotated to about the arm 910 if a hinged type fuel tank assembly is used, for easy replacement of the fuel tank 2007. As before the fuel tank assembly 600 can be attached to the power tool at any attitude and locations.

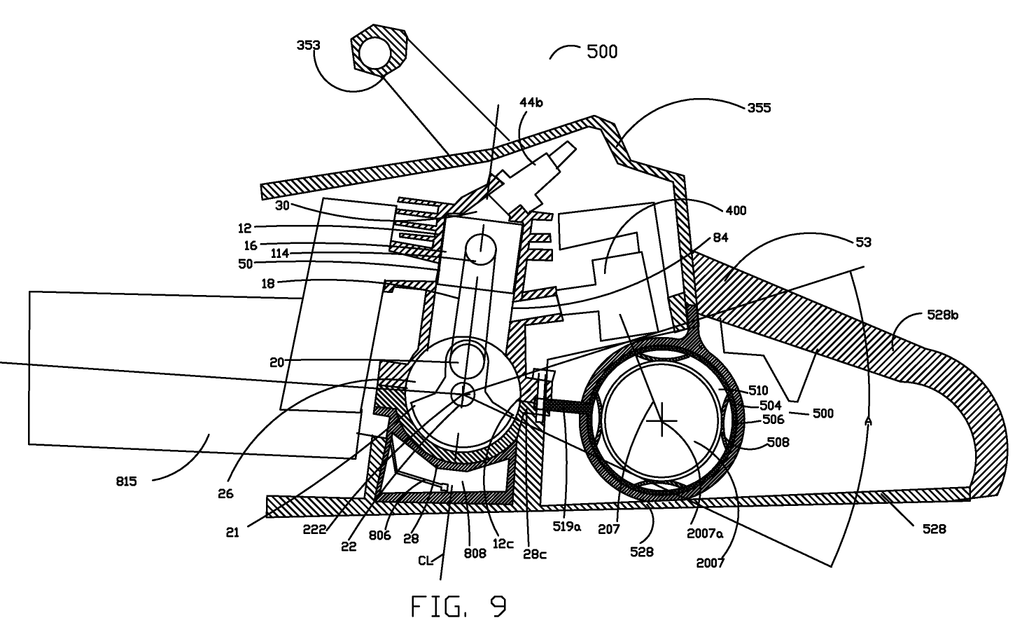

FIG. 9 shows a cross sectional view of a power tool having the fuel tank assembly 500 behind the crankcase 28. The center line 2007a of the fuel tank 2007 is substantially parallel to the axis of the crankshaft 22. It may be noted that the fuel tank housing 504 is located below the carburetor 400 and in the segment between the carburetor and the centerline CL of the cylinder in a plane farther from the center line CL of the cylinder. Angle A describes the segment within which the fuel tank 2007 may be located for compact size of the power tool. Angle A is between the line passing through the axis 222 and the bottom most point of the carburetor 400 and line passing through the axis 222 and that tangential to the fuel tank 2007, as shown in FIG. 9. Angle A is about 135 degrees. Also, it should be noted that the metal casing 506 may be attached to the engine block, specifically the crankcase flange 28c or cylinder flange 12c or it can be sandwiched between the cylinder flange 12c and the crankcase flange 28c.

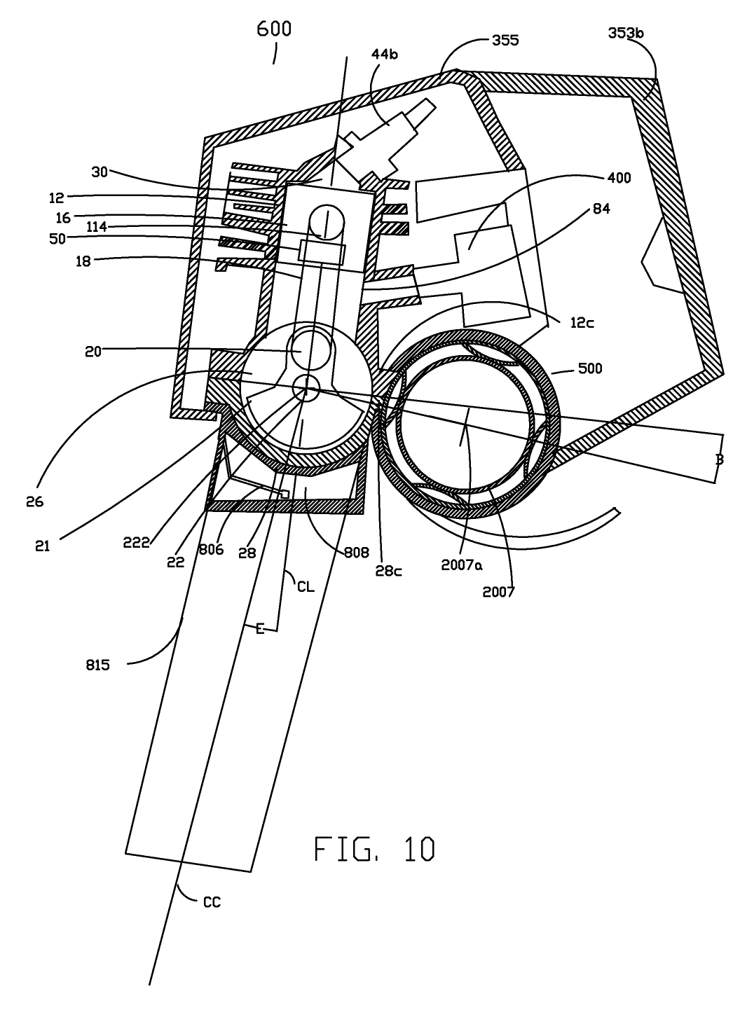

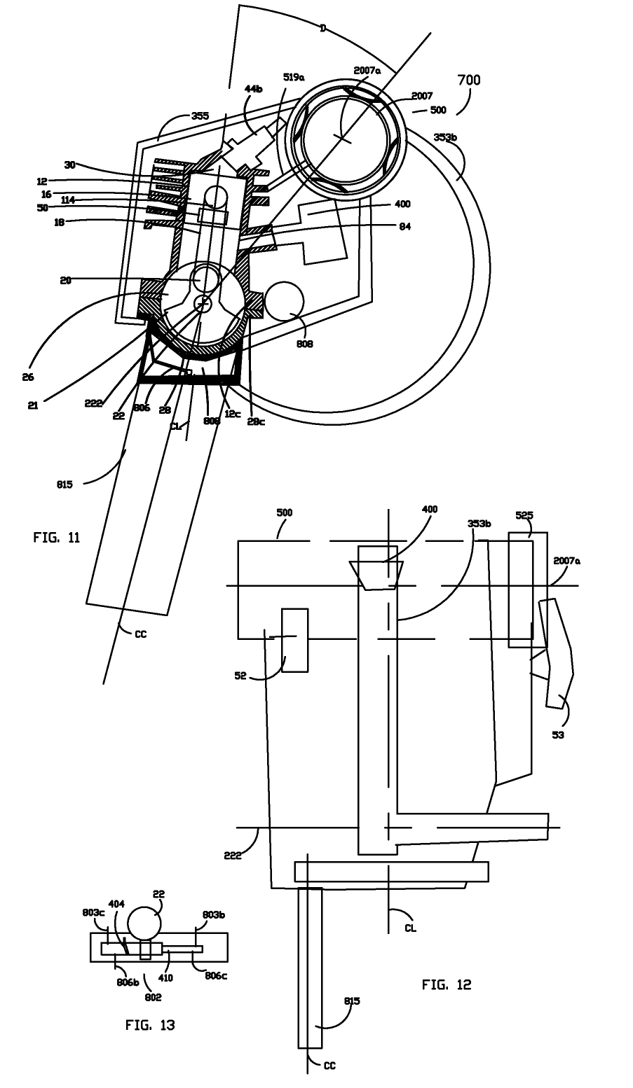

FIGS. 10 and 11 show, what is commonly known as top handle chainsaw, in which the base housing 328 is not present, but has at least one top handle 353b, preferably running from the top of the engine (spark plug side) toward the chain (crankcase side). As shown in the embodiments, the chain bar 815 is typically in line with the axis CL of the cylinder, but can be at a very small angle, less than 45 degrees, and the chain bar is farther from the spark plug. In such engines, the exhaust port 50 is typically at about 90 degrees from the intake port 84. These type of engines have a displacement less than 38 cc. FIG. 10 shows the chainsaw 600, where the fuel tank 2007 is in from of the carburetor 400, but toward the crankcase 28 and the chain bar 815. Part of the metal casing 506 of the fuel tank assembly 500 may be partially integral with the crankcase 28 and partly integral with the cylinder 12. Alternately, the flanges 12c and 28c may conform with the necessary curvature of the metal casing 506. Secondly the metal casing 506 need not be fully wrap 360 degrees around the fuel tank 2007. Also, as shown the top handle 35b3 can be integrally molded with the fuel tank housing 504.

FIG. 11 shows the chainsaw 700 where the fuel tank 2007 is located closer to the spark plug 44b and behind the carburetor 400. The fuel tank assembly 500 is farther away from the chain bar 815. Alternately, the fuel tank 2007 may also be located below the park plug 44b, closer to the muffler (not shown). Typically the exhaust port 50 is away from the plane of the paper (above) and starter assembly is below the plane of the paper. In Chainsaws 600 and 700, the axis 2007a of the fuel tank 2007 is significantly parallel to the axis 222 of the crankshaft. FIG. 12 shows top view of the embodiment shown in FIG. 11.

FIG. 13 shows line diagram of a oil pump 802 having a plunger of two different diameters to deliver different types of oils, one for the engine and the other for the chain. The pump is driven by the crankshaft 22. However, it must be noted that the gaseous fuel may have a pre-mixed oil in the container as disclosed in U.S. Pat. No. 5,701,855.

In another embodiment, the fuel tank assembly 500 may be located closer to the exhaust muffler of an engine so as transfer heat from the muffler through radiation and convection. The size of the fuel tank can range from 2.0 oz to 20.0 oz. The fuel tank 2007 may be made of aluminum, steel, or carbon fiber.

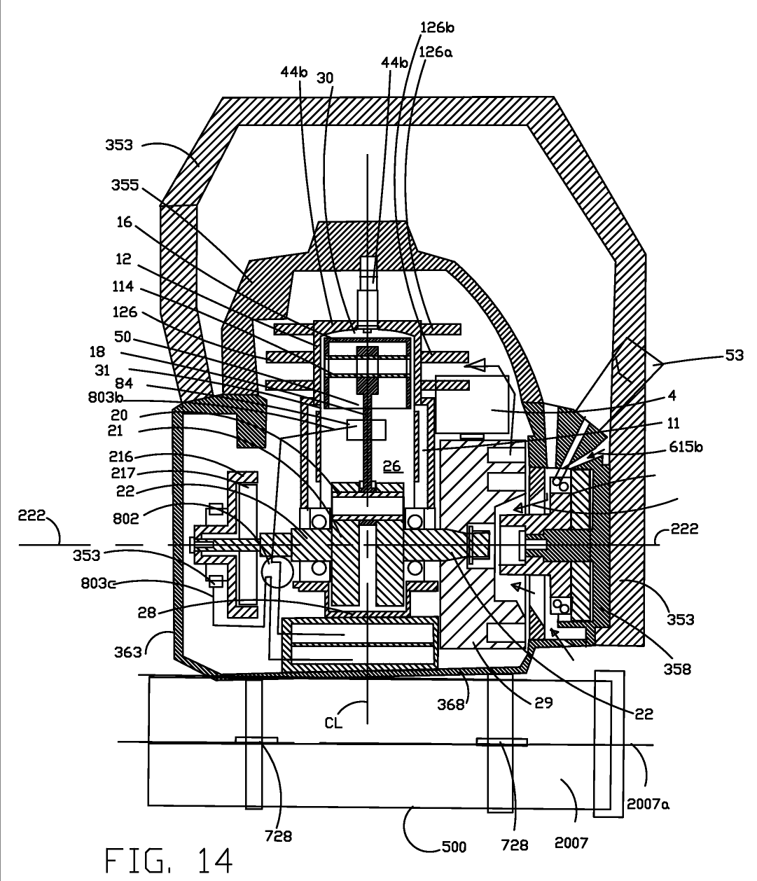

FIG. 14 shows another embodiment where the fuel tank 2007 is attached to the base frame 368. And the axis of the fuel tank 2007a is substantially parallel to the axis 222 of the crankshaft. Also, it is possible to have more than one fuel tank to be attached in a similar manner, where the axis of the fuel tank is parallel to the axis of the crankshaft.

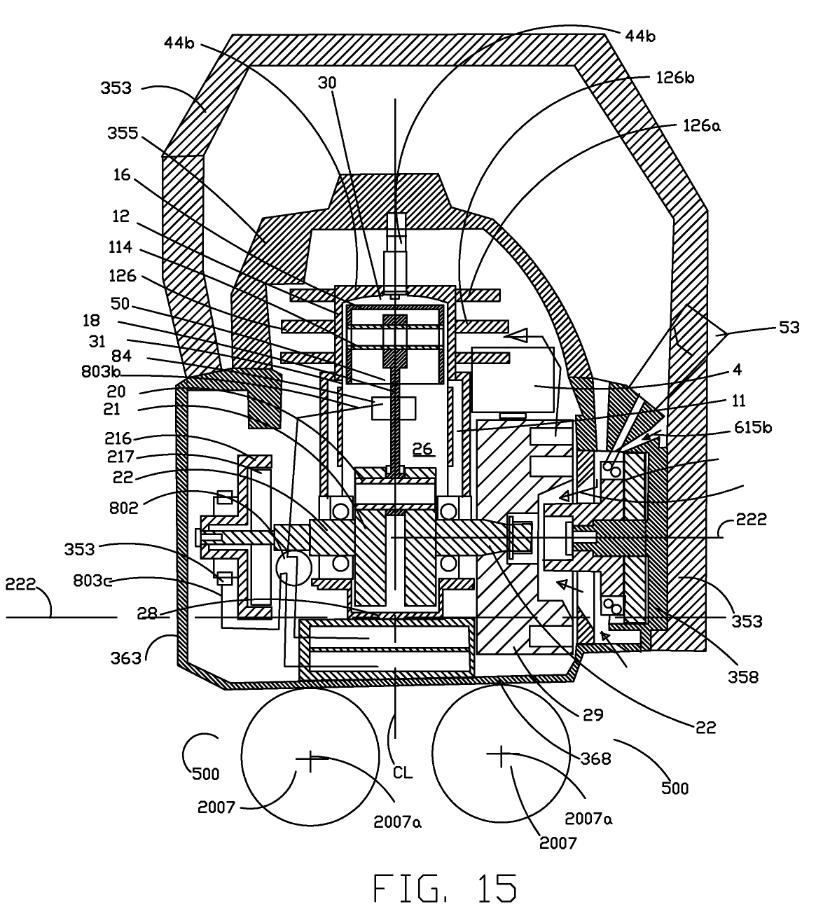

FIG. 15 is similar to the embodiment shown in FIG. 14, but the axis 2007a of the fuel tank 2007 is now substantially perpendicular to the axis 222 of the crankshaft 22.

It must be understood that the embodiments disclosed here are not limited to chainsaws, but also applicable to hand held blower, back pack blower, back pack trimmers, water pumps, compressors, generators, go-peds, scooters, cultivators, edgers, hedge trimmers, etc. Also, the fuel tank assembly 500 may be attached to the starter housing 353, while the chain and clutch is replaced with blower fan as used in blowers or any transmission case for transportation applications.

### PARTS LIST

100 Chainsaw
102 Engine block consisting of cylinder, crankcase, a crankshaft, and a muffler
4 Ignition coil
11 Transfer passage
12 Cylinder
12c Cylinder flange
14 Cylinder wall
16 Piston
18 Connecting rod
20 Crank pin
21 Crank web
22 Crankshaft
22b Crankshaft bearing
22a Crankshaft bearing
26 Crankcase chamber
28 Crankcase
28c Crankcase flange
29 Cooling fan or Flywheel
30 Combustion chamber
31 Transfer port
44 Cylinder head
44b Spark plug
50 Exhaust port
53 Starter handle
84 Intake port
114 Piston pin
126 Cooling fins
126a and 126b Cooling fins
200 Chainsaw having fuel tank behind the engine block 102
205 On-off valve
207a Flexible fuel hose
216 Clutch drum
217 Clutch
222 Crankshaft axis
328 Base Housing
328b Base Handle
353 Handle
353b Top handle
354 Chain
355 Top cover
355b Recess in top cover 355
358 Left side cover
359 Starter assembly
363 Right side cover
368, 528 Base
400 Gaseous fuel supplier/Carburetor
410 Plunger
414 Cut out cam
500 Fuel tank assembly
504 Fuel tank housing
505 Heating air outlet duct
506 Metal casing
508 Supporting member
510 Space between the metal plate and replaceable fuel tank
512a Open slot
512e Outlet passage
519a and 519b Metal elements attached to metal casing 506
522c Ambient air entering slot 512a
522h Open slot for warmer cooling air
522o Outlet on fuel tank assembly
622m Cooling air (mixture of ambient air and air from passage 512e)
525 End cap
528 Base
614 Inlet to fan/flywheel
618, 618a, 618b, 618c) Open slot
615a, 615b Open slot
620 Bi-metal valve
722 U Strap/Clamp
808 Oil tank
806 Oil inlet line to pump 802
806c Oil tank for chain oil
806b Oil tank for engine oil
803c Oil supply line to chain
803b Oil supply line to crankcase chamber

1. A hand-held power tool (100):
a cylinder (12) and a cylinder bore (14);
a crankshaft (22) having a counter weight (21);
a piston (16) connected to the crankshaft (22) through a connecting rod (18) and a crankpin 20;
a combustion chamber (30);
a fuel tank assembly (500) attached to the top cover (355);
ambient air heating the fuel tank as it passes into the inlet of the fooling fan (29); and
fuel is LPG or liquefied Butane.

2. A hand-held power tool having a fuel tank attached to the top cover as claimed in claim 1 further having its centerline 2007a substantially perpendicular to the axis 222 of the crankshaft.

3. A hand-held power tool having a fuel tank attached to the top cover as claimed in claim 2 further having its centerline 2007a substantially perpendicular to the center line CL of the cylinder.

4. A hand-held power tool having a fuel tank attached to the top cover as claimed in claim 3 further having its centerline 2007a between the center line CL of the cylinder and the axis 222 of the crankshaft.

5. A hand-held power tool as claimed in claim 1 cooled by at least a fraction of the cooling air received from the air passing through at least one open slot 512a.

6. A hand-held power tool (200) as claimed claim 1 comprising:
a fuel tank (2007) located between the carburetor (400) and the center line (CL) of the cylinder (12);
centerline (2007a) of the fuel tank (2007) is substantially parallel to the centerline (222) of the crankshaft (22);
ambient air heating the fuel tank as it passes into the inlet of the fooling fan (29); and
fuel is LPG or liquefied Butane

7. A hand-held power tool (300):
a cylinder (12) and a cylinder bore (14);
a crankshaft (22) having a counter weight (21);
a piston (16) connected to the crankshaft (22) through a connecting rod (18) and a crankpin 20;
a combustion chamber (30);
a handle (333);
a fuel tank (2007) attached substantially vertically to the handle (333);
ambient air heating the fuel tank as it passes into the inlet of the fooling fan (29); and
fuel is LPG or liquefied Butane,

8. A hand-held power tool (300):
a cylinder (12) and a cylinder bore (14);
a crankshaft (22) having a counter weight (21);
a piston (16) connected to the crankshaft (22) through a connecting rod (18) and a crankpin 20;
a combustion chamber (30);
a gaseous fuel tank 2007 attached to a connector 904 and a pressure regulator 910; and
an arm 906 mounted on to the fuel tank housing 504 through a dampener dampening bushing 9120.
